(19) United States
(12) Patent Application Publication
(10) Pub. No.: US 2006/0294200 A1
(43) Pub. Date: Dec. 28, 2006

(54) TELEMATICS TERMINAL

(75) Inventor: Sang-Sook LEE, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/425,823

(22) Filed: Jun. 22, 2006

(30) Foreign Application Priority Data
Jun. 23, 2005 (KR) 10-2005-0054674

(51) Int. Cl. G06F 15/16

(52) U.S. Cl. 709/217

(57) ABSTRACT

Accessing a service provided by a telematics terminal includes detecting selection of a link within a Web page displayed by the telematics terminal. The link includes a URL (Uniform Resource Locator) address. A character string associated with a telematics service is identified within the URL address of the selected link. The telematics terminal service is invoked based on the identified character string.

### TECHNICAL FIELD

This document relates to a telematics terminal inside a vehicle.

### BACKGROUND

In general, a telematics terminal is mounted in a car (or other mobile vehicle) and configured to communicate across a wireless communications network and perform various operations including initiating calls, accessing and displaying map information, performing multimedia functions, and providing navigation information using a GPS (Global Positioning System). A telematics terminal also typically includes an audio/video system.

FIG. 1 shows a conventional telematics terminal 100 mounted in a car, and FIG. 2 is a schematic block diagram showing a conventional telematics system. As shown in FIG. 2, the conventional telematics system includes an information providing center 300 for providing telematics service information and the telematics terminal 100 for both receiving the telematics service information through a wireless communication network 200 and providing the received telematics service information to users.

Typical services offered by conventional telematics terminals include a call service, a road guidance service, and an Internet browsing service. When a user of the telematics terminal 100 wants to access the call service of the telematics terminal 100, the user selects a call menu and inputs an arbitrary telephone number into a call destination input field of the call menu. Alternatively, the user may access a telephone book via the call menu and select a specific telephone number to initiate the call. After the telephone number has been specified by the user, the telematics terminal 100 connects the call over the wireless communications network 200.

To access the road guidance service of the telematics terminal 100, the user selects a navigation menu. By interacting with the navigation menu, the user of the telematics terminal 100 may be provided with a driving route from the current position of the vehicle to a selected destination on a map.

The user may browse the Internet by using the Internet browsing service of the telematics terminal 100. However, when the user of the telematics terminal surfs the Internet and finds a Web site listing a phone number of a store that the user wishes to call, the user is forced to manually request the call service by accessing the call menu of the terminal 100 and manually inputting the phone number into an input field. Additionally, if the user wishes to receive road guidance information to drive to the store, the user is forced to manually request the road guidance service by accessing the navigation menu of the terminal 100 and manually specifying the location of the store.

### SUMMARY

In one implementation, a telematics terminal is configured to enable a user to browse the Internet or other information network, access a Web page that is associated with a physical or a geographic address and/or a telephone number, and, through selection of a single graphical element (e.g., an icon or button) on the Web page, automatically receive road guidance information related to the address and/or automatically initiate a call to the telephone number. The user, therefore, does not need to perform any manual steps, such as accessing a call menu or a navigation menu and inputting the phone number or address, to avail himself or herself of the call service or road guidance service offered by the telematics terminal while browsing the Internet.

In one general aspect, accessing a service provided by a telematics terminal includes detecting selection of a link within a Web page displayed by the telematics terminal. The link includes a URL (Uniform Resource Locator) address. A character string associated with a telematics service is identified within the URL address of the selected link. The telematics terminal service is invoked based on the identified character string.

Implementations may include one or more of the following. For example, the telematics service may include one or more of a telephone call connection service and a road guidance service. The URL may include a URL linked to a telephone icon displayed on the Web page and may include a telephone number.

The URL may include a URL linked to a road guidance icon displayed on the Web page and may include road guidance information. The road guidance information may include a road guidance service notification, a destination name, a destination longitude, a destination latitude, and an option. The telematics service character string may include a telephone call service character string.

Accessing a service provided by a telematics terminal may further include detecting a telephone number following the telephone call service character string in response to the telephone call service character string being identified and automatically connecting a telephone call to the telephone number. The telematics terminal character string may include a road guidance service character string.

Accessing a service provided by a telematics terminal may further include detecting the road guidance information following the road guidance service character string in response to the road guidance service character string being identified and displaying a current location of a vehicle and a driving route up to a destination included in the road guidance information based on the road guidance information.

In another general aspect, invoking a service provided by a telematics terminal includes detecting selection of a link having a URL address based on user selection of a graphical icon displayed within a Web page by the telematics terminal, and determining whether a character string within the URL address is associated with a telephone call service provided by the telematics terminal. A telephone number is automatically extracted from the URL address conditioned on the character string being associated with the telephone call service. A call is automatically connected based on the telephone number.

Implementations may include one or more of the following. For example, the graphical element may include an icon. Invoking the service provided by the telematics terminal may further include storing the telephone number.

In another general aspect, accessing a service provided by a telematics terminal includes detecting selection of a link having a URL address based on user selection of a graphical element displayed within a Web page by the telematics terminal, and determining whether a character string within the URL address is associated with a road guidance service provided by the telematics terminal. Road guidance information is automatically extracted from the URL address conditioned on the character string being associated with the road guidance service. Road guidance for a vehicle is performed automatically by displaying a driving route from a current position of the vehicle to a destination based on the road guidance information.

Implementations may include one or more of the following. For example, the road guidance information may include a road guidance service notification, a destination name, a destination longitude, a destination latitude and an option.

The details of one or more implementations are set forth in the accompanying drawings and the description below. Other features will be apparent from the description and drawings, and from the claims.

### LIST OF FIGURES

FIG. 1 is an illustration of a telematics terminal mounted in a vehicle.

FIG. 2 is a block diagram showing a conventional telematics system.

FIG. 3 is a block diagram showing exemplary telematics services provided by a telematics terminal.

FIG. 4 is a user interface showing a Web page displayed on a screen of the telematics terminal.

FIG. 5 is a flow chart showing a process for initiating a telephone call service.

FIG. 6 is a user interface showing a Web page displayed on the screen of the telematics terminal.

FIG. 7 is a flow chart showing a process for initiating a road guidance service.

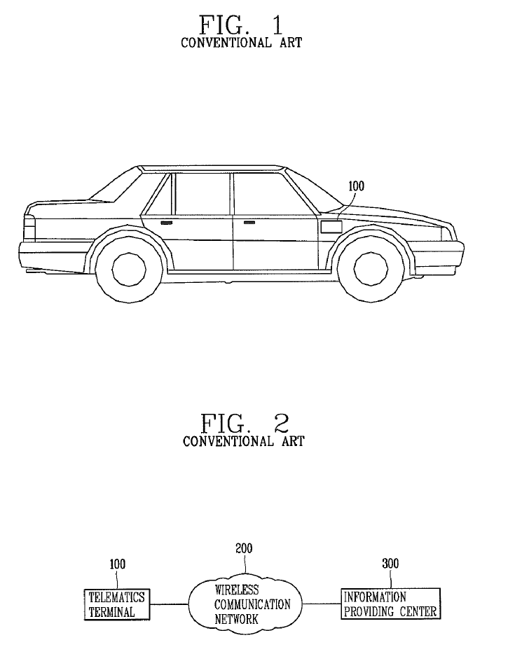

### DETAILED DESCRIPTION

A service system of a telematics terminal enables a user to quickly and easily avail himself of a telematics service when browsing the Internet. The system analyzes the links selected by the user in web pages and detects whether any of the selected links are associated with a URL that includes a “telematics terminal interworking protocol.” The telematics terminal interworking protocol includes a telematics service character string, which identifies a specific telematics service to be invoked, and additional data, such as a telephone number or road guidance data. Selection of the link associated with the URL having the telematics terminal interworking protocol results in invocation or execution of the specific telematics service specified by the telematics service character string. The user, therefore, does not need to perform any manual steps, such as accessing a telematics service menu and/or manually inputting data, to avail himself or herself of the telematics service while browsing the Internet. In another implementation, rather than having the URL include a telematics interworking protocol to identify a desired service, the system analyzes the links selected by the user in web pages and determines whether any of the selected links is associated with a telematics service by performing pattern recognition on the contents of the link. For example, if the link includes information that is recognized as corresponding to a phone number, the system automatically invokes a call service, and/or if the link includes information that is recognized as corresponding to an address, the system may automatically invoke the road guidance service.

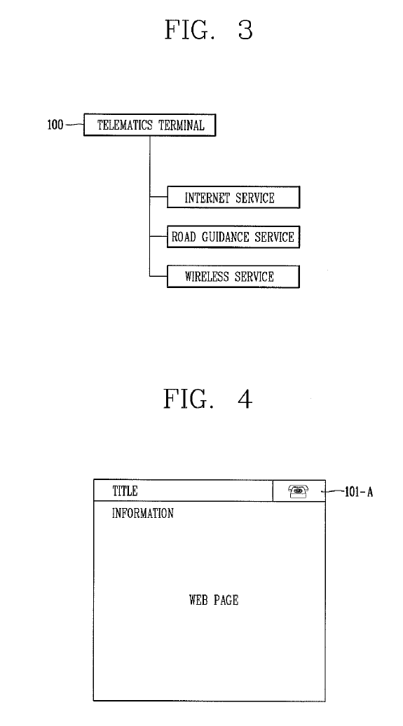

FIG. 3 is a block diagram showing exemplary telematics services provided by a telematics terminal. As shown in FIG. 3, a telematics terminal 100 is configured to provide an Internet browsing service by executing, for example, a Web browser module, a road guidance service by executing, for example, a navigation module, and a wireless service by executing, for example, a communications module. Besides the Internet browsing service, the road guidance service and the wireless service (e.g., a wireless call service), the telematics terminal 100 is also configured to provide various wireless services such as an Internet connection service, an e-mail service, a digital video/audio file downloading service, and a vehicle traffic information service.

FIG. 4 is a first user interface showing a Web page displayed on a screen of the telematics terminal 100. As shown in FIG. 4, the displayed Web page includes an icon 101-A. The icon 101-A is linked to a URL that includes a telematics terminal interworking protocol. In general, when a user selects the icon 101-A, the terminal 100 automatically invokes the telematics service specified by the telematics service character string of the telematics terminal interworking protocol included in the URL linked to the icon 101-A. While FIG. 4 shows icon 101-A as a telephone icon associated with a telephone call service, icon 101-A may be a different graphical icon or element associated with a different service including, for example, a road guidance service or a file downloading service. The telephone icon 101-A may be located in various locations on the display, including on a browser toolbar, a browser frame surrounding a browser window, a floating location in the browser window, and positioned near or next to web contents relevant to the telephone number that are displayed by the browser.

In FIG. 4, the URL linked to the telephone icon 101-A may be, for example: ‘http://www.Ige.com/wireless/do/Food/Favorites?AutoCallService=123456789.’ In this example, the URL includes the telematics service character string “AutoCallService” and the telephone number “123456789”. When a user selects the telephone icon 101-A, the telematics terminal 100 detects the “AutoCallService” string and reacts to that string by storing the telephone number 123456789 and invoking the wireless call service of the telematics terminal 100, thereby automatically initiating a telephone call to the telephone number 123456789 in response to user selection of the telephone icon 101-A.

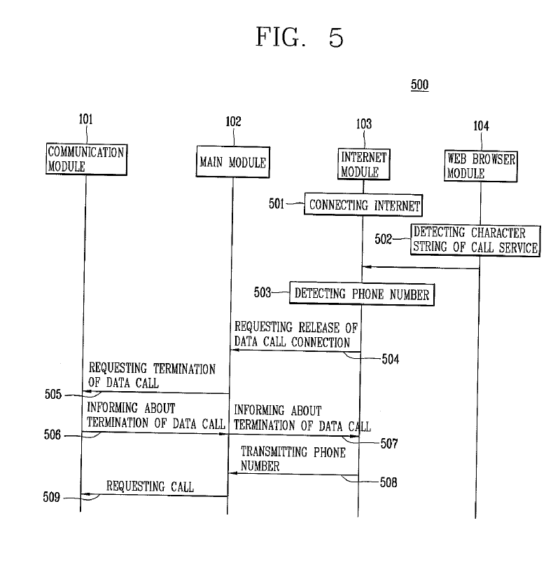

FIG. 5 is a flow chart showing an exemplary process 500 for accessing a telephone call service. For convenience, the process 500 shown in FIG. 5 references particular componentry 101-104. However, similar methodologies may be applied in other implementations where different componentry is used to define the structure of the system, or where the functionality is distributed differently among the components 101-104.

An Internet module 103 of the telematics terminal 100 connects to the Internet (501). A Web browser module 104 of the telematics terminal 100 displays a Web page selected by the user on the screen of the telematics terminal. The displayed Web page may be, for example, the Web page shown in FIG. 4. When the telephone icon 101 -A displayed on the Web page is selected by the user, the Web browser module 104 detects the telematics terminal interworking protocol and associated telephone service character string included in the URL by parsing the URL (502). When the telephone service character string is detected, the Web browser module 104 informs the Internet module 103 of the selection by the user to invoke the telephone call service.

The Internet module 103 then detects a phone number following the telephone call service string within the URL by parsing the URL, typically stops providing the Internet browsing service, and stores the detected phone number (503). The Internet module 103 requests a data call disconnection from a main module 102 (504). The Internet module 103 communicates with various modules (applications) within the telematics terminal 100 and receives various information from the Web browser module 104.

In response to the disconnection request, the main module 102 requests termination of the data call from the communication module 101 (505). The main module 102 controls the overall operation of the telematics terminal 100.

The communication module 101 terminates the data call according to the request, and transmits a notification message notifying the main module 102 and the Internet module 103 about the termination of the data call (506 and 507). Disconnection of the data call typically prevents the user from continuing to browse the Internet (i.e., from receiving further data across the Internet).

After the data call has been terminated, the Internet module 103 transfers the stored phone number to the main module 102 (508). After receiving the phone number, the main module 102 transfers the phone number to the communication module 101 and requests a call connection from the communication module 101 (509).

The communication module 101 automatically connects the telephone call to the stored phone number in accordance with the call connection request received from the main module 102.

In sum, when the user selects the telephone icon 101-A displayed on the Web page of FIG. 4, the communication module 101 automatically connects the telephone call to the telephone number included in the URL linked to the telephone icon 101-A. Thus, the user does not need to directly input the telephone number corresponding to the telephone icon 101-A as a menu input item of a call service menu. The communication module 101 (e.g., a code division multiple access module) controls a communication modem (not shown) and message transmission/reception, call destination/origination, and data call connection/disconnection.

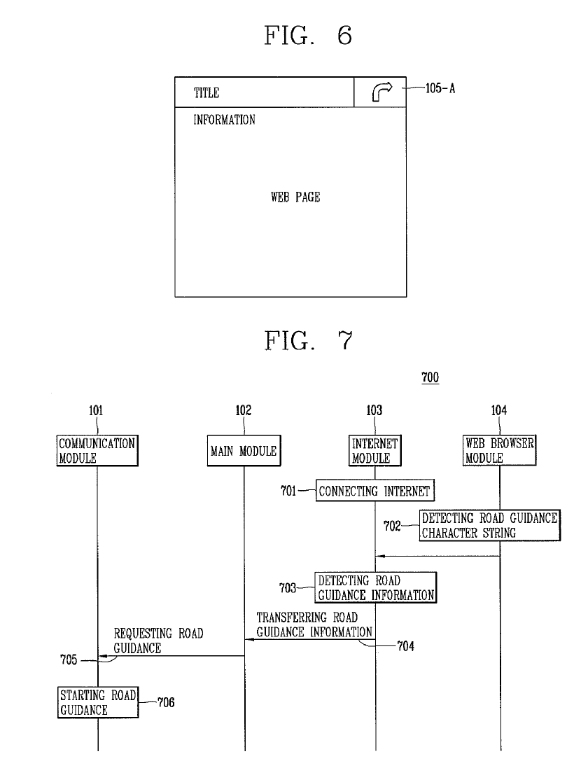

FIG. 6 is a second user interface showing a Web page displayed on a screen of the telematics terminal 100. As shown in FIG. 6, the displayed Web page includes an icon 105-A. The icon 105-A is linked to a URL that includes a telematics terminal interworking protocol. While FIG. 4 shows an icon 101-A as a telephone icon associated with a telephone call service, FIG. 6, correspondingly, yet in contrast, shows an icon 105-A as a road guidance icon associated with a road guidance service. The icon 105-A may be located in various locations on the display, including on a browser toolbar, a browser frame surrounding a browser window, a floating location in the browser window, and positioned near or next to web contents relevant to an address or location displayed by the browser.

In FIG. 6, the URL linked to the road guidance icon 105-A may be, for example: ‘http://www.Ige.com/wireless/do/Travel/Seoul?AutoNaviService&Name=Washington&amp;Longitude=77.00&Latitude=38.55.’ In this example, the URL includes the telematics service character string “AutoNaviService&Name=destination name&Longitude=destination longitude&Latitude=destination latitude&Option=option,” which notifies the terminal 100 that the link corresponds to a road guidance service. The URL further includes a specific destination name, a destination longitude, a destination latitude, and an option. The option may include, for example, the category, type, or classification of the destination (e.g., bank, restaurant, museum, and gas station). When a user selects the road guidance icon 105-A, the telematics terminal 100 may detect the “AutoNaviService&Name” character string, store the destination name, destination longitude and latitude, and the option, and react to the string by invoking the road guidance service of the telematics terminal 100, thereby automatically providing road guidance to the user in response to user selection of the road guidance icon 105-A.

FIG. 7 is a flow chart showing an exemplary process 700 for accessing a road guidance service. For convenience, the process 700 shown in FIG. 7 references particular componentry 102-105. However, similar methodologies may be applied in other implementations where different componentry is used to define the structure of the system, or where the functionality is distributed differently among the components 102-105.

The Internet module 103 of the telematics terminal 100 connects to the Internet (701). The Web browser module 104 of the telematics terminal 100 displays a Web page selected by the user on the screen of the telematics terminal. The displayed Web page may be, for example, the Web page shown in FIG. 6. When the road guidance icon 105-A displayed on the Web page is selected by the user, the Web browser module 104 detects the telematics terminal interworking protocol and associated road guidance service character string included in the URL by parsing the URL (702). When the road guidance service character string is detected, the Web browser module 104 informs the Internet module 103 of the selection by the user to invoke the road guidance service.

The Internet module 103 then detects the road guidance information following the telephone call service string within the URL by parsing the URL, typically stops providing the Internet browsing service, and stores the detected road guidance information (e.g., destination name, destination longitude and latitude, and option) (703). The Internet module 103 transfers the road guidance information to the main module 102 (704).

In response to receiving the road guidance information, the main module 102 delivers the road guidance information to a navigation module 105 and requests road guidance service (705). The navigation module 105 automatically performs the road guidance service based on the road guidance information in response to the request (706). In sum, when the user selects the road guidance icon 105-A displayed on the Web page of FIG. 6, the navigation module 105 automatically performs the road guidance service based on the road guidance information included in the URL linked to the road guidance icon 105A. Thus, the user does not need to personally input road guidance information corresponding to the road guidance icon 105-A in an input item of a navigation menu.

In another implementation, the phone icon 101 -A and/or the road guidance icon 105-A are replaced by menu options in a menu accessible to the user. Menu options to launch a call service or road guidance services are included in the menu, for example, only if the web page and/or link selected by a user includes a telematics interworking protocol or is recognized as being associated with a telephone number and/or address.

Other implementations are within the scope of the following claims

What is claimed is:

1. A method of accessing a service provided by a telematics terminal, the method comprising:
detecting selection of a link within a Web page displayed by the telematics terminal, the link including a URL (Uniform Resource Locator) address;
identifying, within the URL address of the selected link, a character string associated with a telematics service; and
invoking the telematics service based on the identified character string.

2. The method of claim 1, wherein the telematics service includes a telephone call connection service.

3. The method of claim 1, wherein the telematics service includes a road guidance service.

4. The method of claim 1, wherein the URL comprises a URL linked to a telephone icon displayed on the Web page, the URL including a telephone number.

5. The method of claim 1, wherein the URL comprises a URL linked to a road guidance icon displayed on the Web page, the URL including road guidance information.

6. The method of claim 5, wherein the road guidance information includes a road guidance service notification, a destination name, a destination longitude, a destination latitude, and an option.

7. The method of claim 1, wherein the telematics service character string comprises a telephone call service character string.

8. The method of claim 7, further comprising:
detecting a telephone number following the telephone call service character string in response to the telephone call service character string being identified; and
automatically connecting a telephone call to the telephone number.

9. The method of claim 8, wherein the telematics service character string comprises a road guidance service character string.

10. The method of claim 9, further comprising:
detecting road guidance information following the road guidance service character string in response to the road guidance service character string being identified; and
displaying a current location of a vehicle and a driving route up to a destination included in the road guidance information based on the road guidance information.

11. A service system for a telematics terminal, the system comprising:
a first module configured to:
detect selection of a link within a Web page displayed by the telematics terminal, the link including a URL (Uniform Resource Locator) address, and
identify, within the URL address of the selected link, a character string associated with a telematics service; and
a second module configured to execute a specific telematics service in response to detecting the identified character string.

12. The system of claim 11, wherein the URL comprises a URL linked to a telephone icon displayed on the Web page, the URL including a telephone number.

13. The system of claim 11, wherein the URL comprises a URL linked to a road guidance icon displayed on the Web page, the URL including road guidance information.

14. The system of claim 11, wherein the character string comprises a telephone call service character string.

15. The system of claim 14, wherein the first module comprises:
a Web browser module configured to identify the telephone call service character string; and
an Internet module configured to detect a telephone number following the telephone call service character string.

16. The system of claim 15, wherein the second module comprises a communication module configured to automatically place a telephone call to the telephone number.

17. The system of claim 11, wherein the character string comprises a road guidance service character string.

18. The system of claim 17, wherein the first module comprises:
a Web browser module configured to identify the road guidance service character string; and
an Internet module configured to detect road guidance information following the road guidance service character string.

19. The system of claim 18, wherein the second module comprises a navigation module configured to display a current location of a vehicle and a driving route up to a destination included in the road guidance information based on the road guidance information.

20. A method of invoking a service provided by a telematics terminal, the method comprising:
detecting selection of a link based on user selection of a graphical element displayed within a Web page by the telematics terminal, the link including a URL (Uniform Resource Locator) address;
determining whether a character string within the URL address is associated with a telephone call service provided by the telematics terminal;
extracting, from the URL address, a telephone number conditioned on the extracted character string being associated with the telephone call service; and
automatically connecting a call based on the telephone number.

21. The method of claim 20, wherein the graphical element comprises an icon.

22. The method of claim 20, further comprising storing the telephone number.

23. A method of invoking a service provided by a telematics terminal, the method comprising:
detecting selection of a link based on user selection of a graphical element displayed within a Web page by the telematics terminal, the link including a URL (Uniform Resource Locator) address;
determining whether a character string within the URL address is associated with a road guidance service provided by the telematics terminal;
extracting, from the URL address, road guidance information conditioned on the extracted character string being associated with the road guidance service; and
automatically performing road guidance for a vehicle by displaying a driving route from a current position of the vehicle to a destination based on the road guidance information.

24. The method of claim 23, wherein the road guidance information includes a road guidance service notification, a destination name, a destination longitude, a destination latitude and an option.

25. The method of claim 23, wherein the graphical element comprises an icon.

26. The method of claim 23, further comprising storing the road guidance information.

27. A service system of a telematics terminal comprising:
a Web browser module configured to:
detect selection of a link based on user selection of a graphical element displayed within a Web page by the telematics terminal, the link including a URL (Uniform Resource Locator) address, and
determine whether a character string within the URL address is associated with a telephone call service provided by the telematics terminal;
an Internet module configured to extract, from the URL address, a telephone number conditioned on the extracted character string being associated with the telephone call service; and
a communication module configured to connect a call based on the telephone number.

28. A service system of a telematics terminal comprising:
a Web browser module configured to:
detect selection of a link based on user selection of a graphical element displayed within a Web page by the telematics terminal, the link including a URL (Uniform Resource Locator) address, and
determine whether a character string within the URL address is associated with a road guidance service provided by the telematics terminal;
an Internet module configured to extract, from the URL address, road guidance information conditioned on the extracted character string being associated with the road guidance service; and
a navigation module configured to perform road guidance for a vehicle based on the road guidance information.
